(19) United States
(12) Patent Application Publication
(10) Pub. No.: US 2010/0028049 A1
(43) Pub. Date: Feb. 4, 2010

(54) IMAGE FORMING APPARATUS

(76) Inventors: Koji Wakamoto, Osaka (JP); Junya Masuda, Osaka (JP); Masato Kaneko, Osaka (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/494,392

(22) Filed: Jun. 30, 2009

(30) Foreign Application Priority Data
Jul. 30, 2008 (JP) 2008-196356

(51) Int. Cl. G03G 15/04

(52) U.S. Cl. 399/221

(57) ABSTRACT

An image forming apparatus including: a cylindrical photoconductor; a laser scanning section that includes a polygonal mirror and allows a laser beam to reflect off the polygonal mirror and then irradiate a peripheral surface of the photoconductor, so that an electrostatic latent image is formed; an image development section for developing the electrostatic latent image; and a toner storage section for storing the toner to be supplied to the image development section, wherein the image development section is disposed lower than a central axis of the photoconductor, the toner storage section is disposed above the image development section so as to form a space therebetween, and the laser scanning section is disposed so that the rotation axis of the polygonal mirror extends in a vertical direction, and the laser beam reflected from the polygonal mirror reaches to the photoconductor through the space and irradiates a portion of the peripheral surface, which is higher than the central axis of the photoconductor.

### CROSS-REFERENCE TO RELATED APPLICATION

This application is related to Japanese Patent Application No. 2008-196356 filed on Jul. 30, 2008, whose priority is claimed and the disclosure of which is incorporated by reference in its entirety.

### BACKGROUND OF THE INVENTION

1. Field of the Invention

The present invention relates to an image forming apparatus, and more particularly relates to an arrangement of a photoconductor, an image development section, a toner storage section, and a laser scanning section which are used for an electrophotographic process in an image forming apparatus

2. Description of the Background Art

In recent years, along with downsizing of an image forming apparatus, a diameter of a photoconductor drum used for an electrophotographic process is also being downsized. In the case of the apparatus having a medium-speed/low-speed, a photoconductor drum having a diameter of about 30 mm is generally used. This tendency stems from demands for lowering in cost, resource saving, and the like. In addition, characteristics of photoconductor materials and progress in the electrophotographic process technology enables the downsizing. Further, due to the downsizing of the apparatus, a layout which allows a printing sheet to be fed in a vertical direction is introduced (e.g., see Patent Document 1).

Still further, the image forming apparatus is becoming increasingly sophisticated, and an automatic duplex printing function is provided even to an apparatus having a medium-speed/low-speed, as a matter of course, which results from demands for energy saving.

On the other hand, a laser scanning unit (LSU) is widely used for exposing the photoconductor drum. The LSU uses a drive motor (polygon motor) which is directly connected to a rotation axis of a polygonal mirror, i.e., a rotary polygonal mirror, so as to rotate the polygonal mirror about the rotation axis, and also causes a laser beam to be reflected and deflected on the rotating polygonal mirror. In order to realize a high-resolution image forming apparatus, the polygon motor needs to be rotated at an extremely high speed. Along with trends of high-resolution in recent years, the speed of rotation reaches several ten thousand RPM, and the speed of rotation is still likely to increase. It is important for such a high speed rotating body to be arranged with good balance in order to avoid decentering during rotation. In order to avoid the decentering during rotation, a method is proposed in which, a pressuring member for applying pressure to the polygonal mirror and a fixing member for fixing the pressuring member onto a drive motor axis are structured with a single member using a mold spring, and the polygonal mirror is then fixed onto the drive motor with the use of the single member, whereby the polygonal mirror is assembled (see Patent Document 2).

Still further, proposed is an arrangement of a scanning device that exposes the photoconductor drum, the scanning device exposing an off-center portion of the photoconductor to a laser beam (e.g., see description relating to the conventional means in Patent Document 3).
[Patent document 1] Japanese Unexamined Patent Application No. 2006-78575
[Patent document 2] Japanese Unexamined Patent Application No. H05-134201
[Patent document 3] Japanese Unexamined Patent Application No. H61-132921

When a high-speed rotating body such as a polygon motor is situated in an inclined state, a stress is applied to a bearing portion of a rotation axis thereof, which may lead to a problem that a lifetime of the bearing is shortened. Particularly, in the case where a high-speed adaptable hydrodynamic bearing such as an air bearing is applied as a bearing of the polygon motor, if the polygon motor is rotated in a state where an axis thereof is inclined, the rotation is off-balanced, and accordingly, the axis comes in contact with the surrounding bearing member, which may shorten the lifetime of the bearing. Further, in an extreme case, the polygon motor may not be rotated normally. That is, the faster the polygon motor rotates, the more carefully attention needs to be paid with respect to the arrangement of the motor axis.

Further, when the duplex printing is performed on a large number of printing sheets, a printing sheet, whose first surface is heated at the time of printing, comes into contact with the photoconductor at the time of performing transfer onto a second surface of the printing sheet, and consequently the photoconductor drum is heated gradually. The heat conducted to the photoconductor drum is then conducted to the image development section which is in contact with the photoconductor drum, and consequently there may be a case where toner particles are agglomerated in the image development section. In order to prevent such a situation, it is preferable to create airflow to release the heat.

However, along with the downsizing of the diameter of the photoconductor drum, stations such as a laser scanning unit, which execute respective processes relating to the electrophotographic process such as electrostatic charging, developing, transferring, cleaning, and the like, are densely arranged in the vicinity of the photoconductor. Therefore, the position of the laser scanning unit is limited due to positional relation with other stations.

### SUMMARY OF THE INVENTION

The prevent invention is invented in view of the above-described disadvantages, and the present invention provides an image forming apparatus in which a rotation axis of a polygon motor need not be inclined even if respective stations are densely arranged in the vicinity of the photoconductor due to downsizing of the diameter of the photoconductor, and in which the respective stations are disposed so as to effectively release heat from the photoconductor and the image development section.

The present invention provides an image forming apparatus including: a cylindrical photoconductor used for image formation in an electrophotographic process; a laser scanning section that includes a polygonal mirror which rotates on its axis, and a laser beam source, and that allows a laser beam emitted from the laser beam source to reflect off the polygonal mirror and then allows a reflected laser beam to irradiate a peripheral surface of the photoconductor, so that an electrostatic latent image is formed on the peripheral surface; an image development section for developing the electrostatic latent image into a toner image by using a toner; and a toner storage section for storing the toner to be supplied to the image development section, wherein the image development section is disposed lower than a central axis of the photoconductor and in contact with the peripheral surface thereof, the toner storage section is disposed above the image development section so as to form a space therebetween, and the laser scanning section is disposed so that the rotation axis of the polygonal mirror extends in a vertical direction, and the laser beam reflected from the polygonal mirror reaches to the photoconductor through the space and irradiates a portion of the peripheral surface, which is higher than the central axis of the photoconductor.

In the image forming apparatus of the present invention, the laser scanning section is arranged such that the rotation axis of the polygonal mirror is directed in a vertical direction. Accordingly, it is possible to normally and stably rotate the polygon motor for a long period of time. In addition, the toner storage section is arranged above the image development section so as to form a space between the toner storage section and the image development section. A laser beam is arranged with respect to the photoconductor, the image development section and the toner storage section such that the laser beam deflected by the polygonal mirror reaches the photoconductor through the space, and irradiates a portion of the peripheral surface, the portion higher than the central axis of the photoconductor. Accordingly, the heat can be released from the image development section effectively. Namely, airflow toward the photoconductor, which is densely surrounded by various stations, can be generated. Further, the laser scanning section exposes the peripheral surface to the scanning beam through the space, and thus the space can be effectively used as an optical path through which the scanning beam passes, and thus it is possible to realize downsizing of the apparatus.

### BRIEF DESCRIPTION OF THE DRAWINGS

FIG. 1 is a diagram schematically showing an entire configuration of an image forming apparatus of the present invention;

FIG. 2 is a diagram schematically showing respective stations arranged in the vicinity of a photoconductor drum in the image forming apparatus as an embodiment of the present invention;

FIG. 3 is a diagram schematically showing an arrangement of an image developing device, a toner cartridge and an LSU as an embodiment of the present invention;

FIG. 4 is a diagram schematically showing that the exposure point is arranged so that a position higher than the central axis of the photoconductor is exposed;

FIGS. 5A and 5B show diagrams schematically illustrating an internal configuration of an LSU, and an arrangement of the LSU, the image developing device, the toner cartridge, and the photoconductor drum as an embodiment of the present invention; and

FIG. 6 is a diagram schematically showing an arrangement of an image development device, a toner cartridge and an LSU of a conventional technique.

### DETAILED DESCRIPTION OF THE PREFERRED EMBODIMENTS

In the present invention, the photoconductor is of a cylindrical shape. The photoconductor rotates about an axis at the time of image forming in an electrophotographic process. Further, the material and the physical property of the photoconductor are not particularly limited as long as the material and the physical property are adaptable to the electrophotographic process. At the time of image forming, the outer circumferential surface of the photoconductor moves in a single direction (in a second scanning direction). In the case of the photoconductor of the drum shape, the outer circumferential surface moves in response to a rotation of the drum.

The laser scanning section performs laser beam scanning on the outer circumferential surface in its moving direction and also in a direction perpendicular thereto (a first scanning direction), and exposes the outer circumferential surface to the laser beam. The laser scanning section causes a laser beam emitted from a fixed laser source to be reflected and deflected on side surfaces of a rotating polygonal mirror to obtain the scanning beam.

Whether the toner used for development is single component type or dual component type is not a matter of consideration. A configuration in which the image development section and the toner storage section are arranged distant from each other is one of the characteristics of the present invention. The image development section is arranged so as to face the outer circumferential surface of the photoconductor in order to perform development on the outer circumferential surface, and is also arranged in a region extending in a first scanning direction. The toner storage section is arranged so as to be separated from the image development section at a predetermined distance. The predetermined distance is set so as to allow the scanning beam to expose the outer circumferential surface through the space formed between the image development section and the toner storage section.

As above described, the scanning beam scans the outer circumferential surface of the photoconductor in the first scanning direction, and thus at least a part of the toner storage section extends substantially in parallel to the first scanning direction, and forms the space between itself and the image development section.

Hereinafter, preferred embodiments of the present invention will be described.

The image forming apparatus according to the present invention may further include a vertical transport path configured to pass a printing sheet upward while the printing sheet comes in contact with a part of the peripheral surface of the photoconductor; a transfer section for transferring the toner image, which is developed by the image development section, from the peripheral surface of the photoconductor onto the printing sheet; a fixing section that is disposed where the printing sheet is transported to after passing through the transfer section; and a reverse transport path for reversing the printing paper which has passed through the fixing section, and circulating the printing paper to the transfer section, wherein the vertical transport path may guide the printing sheet to the transfer section upward, the printing sheet having been circulated through the fixing section and the reverse transport path after the toner image has been transferred thereonto once in the transfer section. As above described, at the time of duplex printing, a print sheet, whose first surface is heated at the time of its printing, comes into contact with the photoconductor at the time of performing transfer onto a second surface of the print sheet, and consequently the photoconductor drum is heated. With the above-described configuration, however, it is possible to create airflow toward photoconductor drum such that the air is flowed in through the space to release the heat from the photoconductor drum. Accordingly, it is possible to effectively release heat from the photoconductor drum. Therefore, it is possible to prevent a problem that the toner particles are agglomerated inside the image development section due to the heat conducted from the photoconductor drum.

The transfer section transfers the toner onto a printing sheet which passes through while having in contact with a part of a peripheral surface of the photoconductor drum, and thus the transfer section is disposed alongside of the photoconductor drum. The image development section is disposed upstream from the transfer section so as to be in contact with the peripheral surface of the photoconductor. The toner storage section is arranged above the image development section. The laser scanning section is disposed on a lateral side of the photoconductor drum, the lateral side being opposite to the transfer section, and emits a scanning beam in a substantially horizontal direction toward the photoconductor drum. The laser scanning section exposes the peripheral surface via the space arranged between the image development section and the toner storage section.

A most serious disadvantage in the case of downsizing the diameter of the photoconductor drum is a decay time (time required until a surface potential of a part exposed to the scanning beam is stabilized). In the case of downsizing the diameter of the photoconductor drum, in order to ensure a predetermined decay time, an angle between the exposure point exposed to the scanning beam and the developing point, the angle being as viewed from the central axis of the photoconductor drum, needs to be set wide.

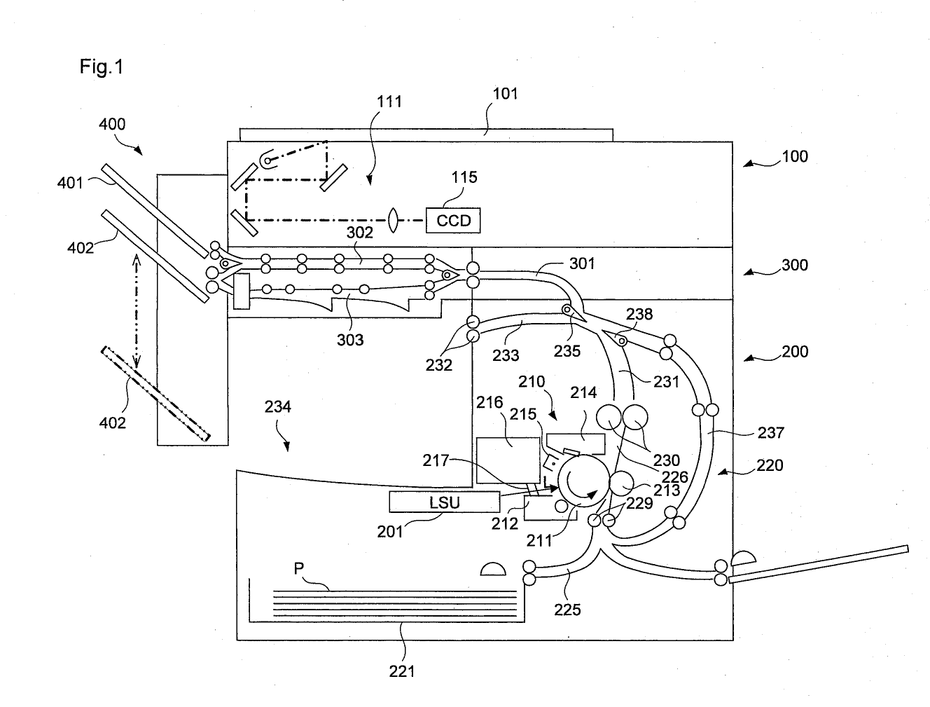

Although detailed explanation will be given later, in a layout having a vertical transport path, as shown in FIG. 1, the image development section is arranged below the drum. Under such a condition, when the toner storage section is arranged above the image development section, an optical path of the scanning beam is interrupted due to the downsizing of the diameter of the photoconductor drum.

In this configuration, in order to keep the angle between the exposure point and the developing point wide, the cleaner and the charger are arranged downstream from the vertical transport path (a side above the transfer section) so as to locate the exposure point at a higher possible position. On the other hand, the image development section needs to be arranged upstream (a side below the transfer section) from the vertical transport path. However, when the cleaner and the charger are actually arranged, the exposure point is located at a position on the peripheral surface of the photoconductor, the position being slightly higher than a horizontal plane including the central axis of the photoconductor.

The toner storage section is preferably arranged above the image development section. This is because such a configuration allows the toner to be supplied to the image development section without defying gravity, and is free from mechanical awkwardness. The simplest arrangement is to arrange the toner storage section immediately above the image development section. Further, as above described, the laser scanning section is preferably disposed such that the rotation axis of the polygonal mirror is directed in a vertical direction. On the other hand, in order to improve the heat releasing property of the image development section, it is preferable to arrange the space for releasing heat in the surrounding area of the image development section. From such a point of view, it is preferable to arrange the toner storage section distant from the image development section.

In order to satisfy such requirements, in the present embodiment, the toner storage section is arranged above the image development section and distant from the image development section by a predetermined distance. In addition, the laser scanning section is arranged on a lateral side of the image development section such that the rotation axis of the polygonal mirror is directed in a vertical direction. Therefore, the scanning beam having been reflected on the polygonal mirror is deflected in a substantially horizontal direction and is outputted from the laser scanning section. The scanning beam travels toward the photoconductor drum through the space formed above the image developing section, and exposes the peripheral surface.

When the laser scanning section is arranged as above described in relation to the photoconductor drum and the respective peripheral stations, it is possible to improve heat releasing property of the image development section and the photoconductor drum. In addition, a predetermined decay time is ensured without having a useless space. Accordingly, it is possible to realize an image forming apparatus that can be downsized.

Further, the laser scanning section exposes a portion of the peripheral surface of the photoconductor drum, the portion being higher than the central axis of the photoconductor. With this configuration, the scanning beam reflected on the peripheral surface returns to the laser scanning section, and thus it is possible to avoid a problem of reduction in the amount of the scanning beam.

The toner transport section may be arranged in the image forming apparatus body including the photoconductor, and the toner storage section and the image development section may be detachable from the image forming apparatus body.

The image development section is disposed so as to perform image development in a region which extends along the central axis of the photoconductor, and the image forming apparatus further includes the toner transport section which is disposed at one end of the image development section, and which communicates the toner storage section to the image development section. The toner transport section may be designed so as to transport the toner stored in the toner storage section to the image development section.

In another words, the image development section may be configured to develop the electrostatic latent image in a region that faces the peripheral surface of the photoconductor and extends along the central axis of the photoconductor, the image forming apparatus may further include a toner transport section that is disposed at one end of the region of the image development section and communicate the toner storage section with the image development section, and the toner transport section may transport the toner stored in the toner storage section to the image development section.

The laser scanning section may further include a bearing that supports the rotation axis of the polygonal mirror, and the bearing may be formed from a hydrodynamic bearing.

The image forming apparatus may further comprising a charging section for charging the peripheral surface of the photoconductor, wherein the charging section may be disposed between the toner storage section and the photoconductor. With this configuration, short decay time of the photoconductor can be realized.

The above-described various types of preferred embodiments may also be realized in combination with one another.

Hereinafter, the present invention will be described in detail with reference to drawings. Note that the following description illustrates examples of the present invention, and should not be construed as limitations to the present invention.

Overall Configuration of an Image Forming Apparatus

First, an overall configuration of an image forming apparatus according to the present invention will be described. Examples of a photoconductor, a laser scanning section, an image development section, a toner storage section, a vertical transport path, a transfer section, and a toner transport section will be described in detail.

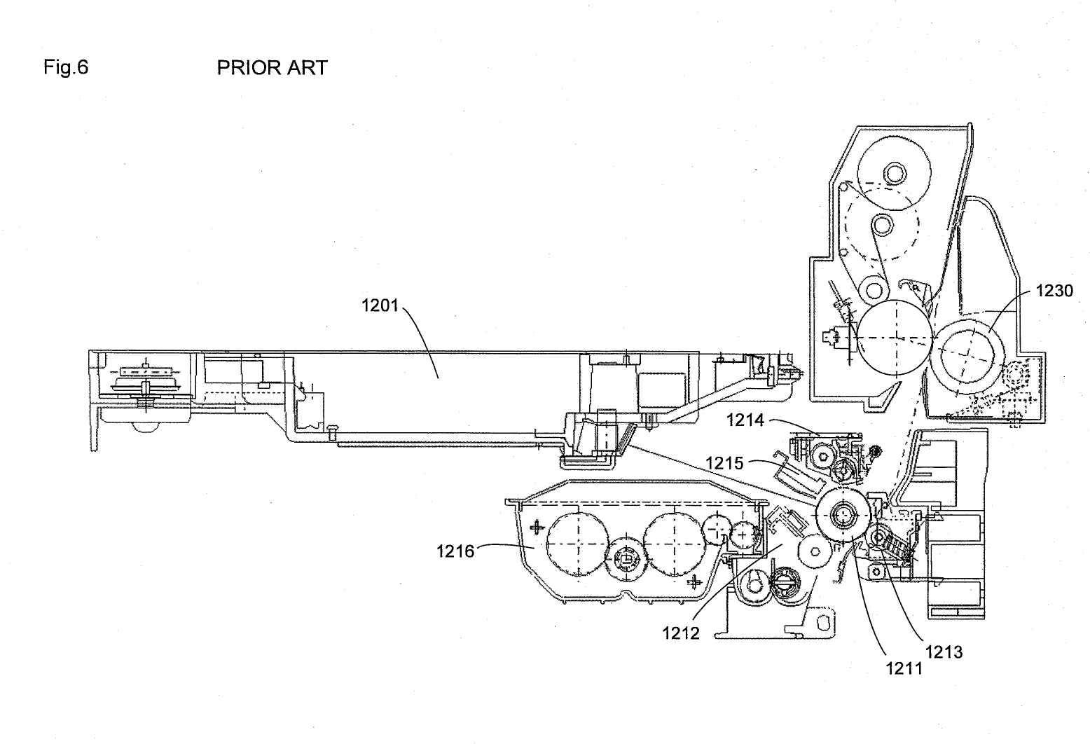

FIG. 1 is a diagram schematically showing an overall configuration of the image forming apparatus of the present invention. As shown in FIG. 6, the image forming apparatus generally includes an original copy reading section 100, an image forming apparatus body 200, a post-processing device 300, and a sheet stack section 400.

The original copy reading section 100 is designed to read an original copy (not shown) placed on a transparent original copy table 101, and, for that purpose, includes a scanner optical system 111. An Image of the original copy is converted to an electrical signal (image signal) by a photoelectric conversion element (CHARGE COUPLED DEVICE (CCD)) 115.

The image forming apparatus body 200 is constituted of an image forming section 210, and a feeder and transport section 220. The image forming section 210 forms an image of the original copy in accordance with the image signal. The feeder and transport section 220 causes printing sheets P to be stored in the feeding cassette 221, and sequentially feeds the stored printing sheets P to a first feeding path 225. The printing sheets fed to the first feeding path 225 are then transported to the image forming section 210.

The image forming section 210 has a photoconductor drum 211 for an electrophotographic process. The photoconductor drum 211 corresponds to the photoconductor of the present invention. Arranged in the vicinity of the photoconductor drum 211 are a main charging device 215, the LSU 201 which corresponds to the laser scanning section of the present invention, a developing device 212 which corresponds to the image development section of the present invention, a transfer roller 213 which corresponds to the transfer section, and a cleaning device 214. A toner cartridge 216, which corresponds to the toner storage section of the present invention, is also arranged. At one peripheral side of the photoconductor drum 211, the developing device 212 and the toner cartridge 216 are communicated with each other having a toner feeder pipe 217 interposed therebetween. The transfer roller 213 corresponds to the transfer section of the present invention, and the toner feeder pipe 217 corresponds to the toner transport section of the present invention.

The main charging device 215 substantially uniformly charges a peripheral surface of the photoconductor drum 211. The photoconductor drum 211 is rotary driven in a direction indicated by an arrow. At a downstream from the main charging device 215 along the indicated direction, there is an exposure point L, on which a laser beam from the LSU 201 is incident. Upon exposure to the laser beam, whose outgoing beam amount is controlled based on the image signal, an electrostatic latent image is formed on the peripheral surface of the photoconductor drum 211. The developing device 212 located downstream from the exposure point L changes the formed electrostatic latent image to a visible image (toner image) by using toner. In the present embodiment, dual-component development is applied.

The transfer roller 213 located downstream from the developing device 212 transfers the developed toner image onto a printing sheet P. The transfer roller 213 is disposed halfway along a vertical transport path 226. The printing sheet P passes through resist rollers 229, and has the toner image transferred thereonto by the transfer roller 213 halfway along the vertical transport path 226. The printing sheet P is then transported to fixing rollers 230 disposed at an end of the vertical transport path. The fixing rollers 230 correspond to the fixing section. The vertical transport path 226 corresponds to the vertical transport path of the present invention. The cleaning device 214 disposed downstream from the transfer roller 213 removes toner remaining on the photoconductor drum 211 after transfer. The cleaning device constitutes a part of the vertical transport path 226. As a modified example, a charge neutralization device may be disposed between the transfer roller 213 and the cleaning device 214 so as to remove an electrical charge remaining on the photoconductor drum 211. In that case, instead of the cleaning device 214, the charge neutralization device constitutes the part of the vertical transport path 226.

As above described, the laser beam from the LSU 201 is controlled based on the image signal representing an image of the original copy. However, the image forming apparatus of the present invention is not limited to such a configuration. Instead, the laser beam may be controlled based on print data received from an apparatus such as an external computer (not shown) or the like connected through a communication line, or based on facsimile data received from a FAX machine connected via a public line. In other words, the image forming apparatus may function as a so-called digital multifunction device.

When the printing sheet P having the toner image transferred thereonto by the transfer roller 213 passes through the fixing rollers 230, the toner is fused and adhered to the surface of the printing sheet P. Then the printing sheet P is transported through a sheet transport path 231, a second switching gate 238, a first switching gate 235, a first sheet exit path 233, and sheet exit rollers 232, and is discharged to the first discharge section 234. Alternatively, the printing sheet P is led to a second sheet exit path 301 of the post-processing apparatus 300 by the first switching gate 235 disposed downstream from the fixing rollers 230, and discharged to a first sheet stack tray 401 or a second sheet stack tray 402 in a sheet stack section 400 through an escape path 302 or a staple tray 303.

Further, the feeder and transport section 220 has a reverse transport path 237 disposed in parallel to the sheet transport path 231. The reverse transport path 237 is designed to perform an automatic duplex printing function to print images on both sides of a printing sheet P. At the time of the automatic duplex printing, the printing sheet P having passed through the fixing rollers 230 is once transported to the sheet exit rollers 232. When a tail end of the printing sheet P has passed the second switching gate 238, the printing sheet P is turned in the reversed direction, led by the second switching gate 238 to the reverse transport path 237, and then transported to the resist rollers 229 disposed upstream from the transfer roller 213. Thereafter, the printing sheet P again passes through the transfer roller 213 and has a toner image transferred onto a sheet surface opposite to the side having a toner image previously transferred. The printing sheet P having the toner image transferred thereonto is transported through the fixing rollers 230, and discharged into the first discharge section 234, the first sheet stack tray 401, or the second sheet stack tray 402.

Layout of the Laser Scanning Section and the Photoconductor and Their Surroundings

Next, a layout of the photoconductor and its surroundings will be described. In the image forming apparatus shown in FIG. 1, for the sake of downsizing the apparatus, such a layout is adopted that causes a printing sheet to be vertically transported on the side of the photoconductor drum 211 and also causes the printing sheet to have a toner image transferred thereonto. Further, for the sake of the downsizing, the photoconductor having a smallest possible diameter is arranged. In the present embodiment, the photoconductor has a diameter of 30 mm. In consideration of characteristics of the electrophotographic process, a decay time of the photoconductor is posed as a problem when the diameter of the photoconductor is downsized without changing a process speed (moving speed of the peripheral surface of the photoconductor). The decay time is alternatively defined as a traveling time of a point on the peripheral surface of the photoconductor drum 211, the point traveling between the exposure point L and a point (developing point) where an electrostatic latent image is caused to be visible by the developing device 212. Under a predetermined process speed condition, the traveling time is determined based on an arc distance between the exposure point L and the developing point along the peripheral surface of the photoconductor.

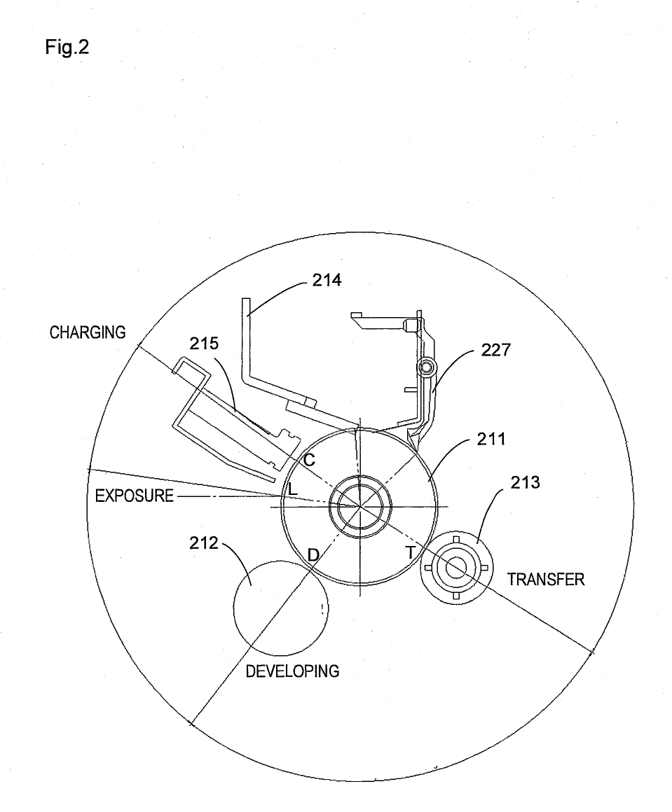

FIG. 2 is a diagram schematically showing respective stations arranged in the vicinity of a photoconductor drum 211 in the image forming apparatus as an embodiment of the present invention. FIG. 2 shows a shape of the photoconductor drum 211 as viewed from a distant point extending from a rotation axis thereof. FIG. 2 shows an arrangement of the main charging device 215, the developing device 212, the transfer roller 213, and the cleaning device 214. The right side surface of the cleaning device 214 constitutes a part of the vertical transport path 226, and on the surface, a separation claw 227 physically separating the printing sheet P from the photoconductor drum 211 is disposed.

In FIG. 2, the exposure point on the peripheral surface of the photoconductor drum 211 is denoted by reference character L, and the developing point is denoted by reference character D. Further, an arc distance between the exposure point L and the developing point D along the peripheral surface of the photoconductor drum 211 is denoted by reference character Pld. Still further, a point where electrostatic charging is performed, and a point where transfer is performed, on the peripheral surface of the photoconductor drum 211, are denoted by reference characters C and T, respectively.

The decay time is obtained by dividing the distance Pld by the process speed. In order to downsize the diameter of the photoconductor drum 211 without changing the process speed, the arc distance Pld needs to be kept constant even if the diameter of the photoconductor drum 211 is reduced. Accordingly, an angle between the exposure point L and the developing point D as viewed from the rotation axis of the photoconductor drum 211 needs to be set wide.

When the vertical transport path is arranged on the right side of the photoconductor drum 211, positions of the transfer point T and the cleaning device 214 are determined independently of the diameter of the photoconductor drum 211. At the transfer point T, minute toner particles need to be transferred onto the surface of the printing sheet P without having wobbling, halation, and scattering. The transferred yet-to-be-fixed toner then needs to be transported to the fixing rollers 230. Therefore, it is necessary to feed the printing sheet P from the transfer point T to the fixing rollers 230 such that an unnecessary external force is not applied to the printing sheet P during its transport. Inevitably, the vertical transport path is determined to be located at such a path that allows the printing sheet P to travel in a straight line.

When the angle between the exposure point L and the developing point D is increasingly set wider along with the downsizing of the diameter, the developing point D comes increasingly closer to the upstream (lower) side of the vertical transport path 226, whereas the electrostatic charge point C and the exposure point L come increasingly closer to the downstream (upper) side of the vertical transport path 226. However, the cleaning device 214 needs to have its cleaning blade in contact with the peripheral surface of the photoconductor drum 211 to form an acute angle therebetween and also needs to have a space to discharge collected toner. Therefore, the downsizing is performed in a limited manner. Further, the developing device 212 needs to have an agitation mechanism and a convection mechanism in order for the toner fed from the toner cartridge 216 to be uniformly supplied to the developing point D. Therefore, the downsizing is performed in a limited manner.

In view of these limited conditions, the exposure point L is limited to a position slightly higher than a horizontal plane including the rotation axis of the photoconductor. Further, the developing point D is limited to a position slightly closer to the exposure point L than a vertical plane including the rotation axis of the photoconductor, as shown in FIG. 2.

Here, a location of the toner cartridge 216 is posed as a problem along with the downsizing of the diameter. It is preferable to arrange the toner cartridge 216 above the image development section such that the toner can be supplied to the image development section without defying gravity.

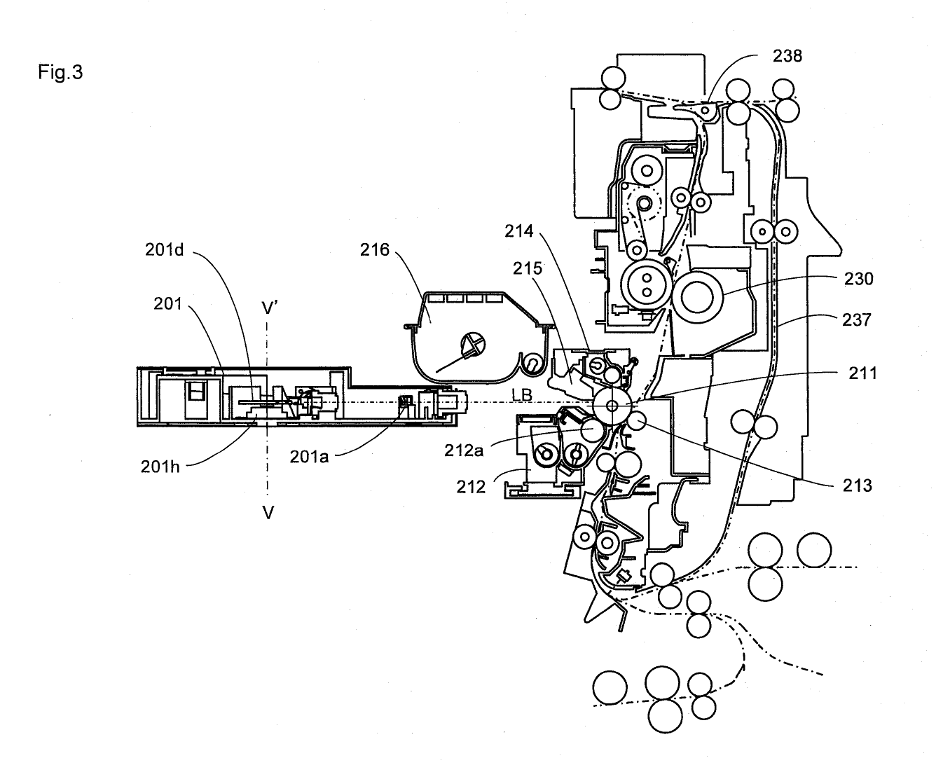

FIG. 3 is a diagram schematically showing an arrangement of the image developing device 212, the toner cartridge 216, and the LSU 201 in the image forming apparatus according to an embodiment of the present invention. FIG. 3 also shows the arrangement of the photoconductor drum 211, the main charging device 215, the transfer roller 213, and the cleaning device 214 shown in FIG. 2, and the arrangement of the fixing rollers 230. As shown in FIG. 3, the toner cartridge 216 is disposed above the developing device 212, and the toner cartridge 216 and the developing device 212 are separated from each other so as to have a space therebetween. The LSU201 is disposed on a lateral side of the space, and on the left side of the developing device 212 and the toner cartridge 216. The LSU201 includes thereinside a polygonal mirror 201d, and a polygon motor 201h which causes the polygonal mirror 201d to rotate, and a laser diode 201a which is a laser light source. A rotation axis of the polygon motor 201h is directly connected to the polygonal mirror 201d, and is directed in a vertical direction (V-V′ direction shown in FIG. 3). The laser beam emitted from the laser diode 201a is reflected on the rotating polygonal mirror 201d, and changed into a scanning beam LB which is deflected in the horizontal direction. The scanning beam LB is emitted in a substantially horizontal direction, and reaches the photoconductor drum 211 through the space. The exposure point on the peripheral surface of the photoconductor drum 211 is situated at a position slightly higher than the rotation center of the photoconductor drum 211, and slightly downstream from the main charging device 215.

The main charging device 215 is disposed between the photoconductor drum 211 and the toner cartridge 216, and charges an adjacent part of the peripheral surface of the photoconductor drum 211 to the exposure point. With such a layout of the main charging device 215, short decay time of the photoconductor can be realized.

Heat releasing space between the developing device and the photoconductor drum In the developing device 212, the toner is agitated and moves convectively, and consequently friction heat occurs. In addition, when the automatic duplex printing is performed, a printing sheet, whose first surface undergoes a transfer process and is heated with the fixing rollers 230, passes though the reverse transport path 237, and comes into contact with the photoconductor drum 211 when the second surface undergoes the transfer process. When the automatic duplex printing is performed on a large number of printing sheets, a temperature of the photoconductor drum 211 is gradually increased due to the heat transported by the printing sheets.

The developing device 212 has a developing roller 212a. The developing roller 212a has a magnet located thereinside, and a magnetic brush is formed on its peripheral surface by the action of the magnet. The developing roller 212a is located so as to face the peripheral surface of the photoconductor drum 211, and the magnetic brush is in contact with the peripheral surface of the photoconductor drum 211. When the temperature of the photoconductor drum 211 is increased, the heat is transported to the developing roller 212a and a developing agent (toner and carrier) in the developing device through the magnetic brush. Even after printing is completed and the agitation in the developing device 212 stops, the magnetic brush is in contact with the photoconductor drum 211, and the toner is heated by residual heat of the photoconductor drum 211. When such a situation continues for a long period of time, the toner particles are agglomerated inside the developing device 211, which adversely effects print image quality. In order to avoid such a problem, heat releasing performance of the developing device 211 needs to be improved.

As aforementioned, in the present embodiment, the toner cartridge 216 and the developing device 212 are arranged so as to be separated from each other. Since the developing device 212 is surrounded by space, the developing device 212 exerts favorable heat releasing performance. In addition, due to the space, it is possible to create airflow toward the photoconductor.

In order to soundly understand the characteristics of the present invention, a conventional layout will be shown. FIG. 6 is a diagram schematically showing an arrangement of a developing device, a toner cartridge, and an LSU in a conventional image forming apparatus. In FIG. 6, a photoconductor drum is denoted by reference number 1211, the developing device is denoted by reference number 1212, the toner cartridge is denoted by reference number 1216, and the LSU is denoted by reference number 1201. Further, a main charging device, a transfer roller, a cleaning device, and a fixing roller are denoted by reference numbers 1215, 1213, 1214, and 1230, respectively. A part of the toner cartridge 1216 is in contact with an upper part of the developing device 1212, and an opening is arranged at the contact portion such that toner is poured and supplied from the toner cartridge 1216 to the developing device 1212 through the opening.

The LSU 1201 emits the scanning beam so as to expose the photoconductor drum 1211 from obliquely upward. Thus, in the LSU 1201, in order to arrange the polygonal mirror while inclining the rotation axis, or alternatively, in order to arrange the polygonal mirror such that the rotation axis is directed in the vertical direction, a reflection mirror, which downwardly deflects the scanning beam having been reflected by the polygonal mirror needs to be arranged. As a result, the number of component parts used for the optical system is increased. This hinders thinning of the LSU 1201. In this regard, the image forming apparatus shown in FIG. 3 excels in heat releasing performance since there is a space arranged above the developing device 212. Further, the space above the developing device 212 is also used as a path for the scanning beam to travel through. In other words, the limited space surrounding the photoconductor drum 211 is utilized effectively. Still further, as will be clear when FIG. 3 is compared with the layout shown in FIG. 1, the LSU 201 located in a space under the first discharge section 234 may be located at a further lower position, which enhances downsizing of the image forming apparatus.

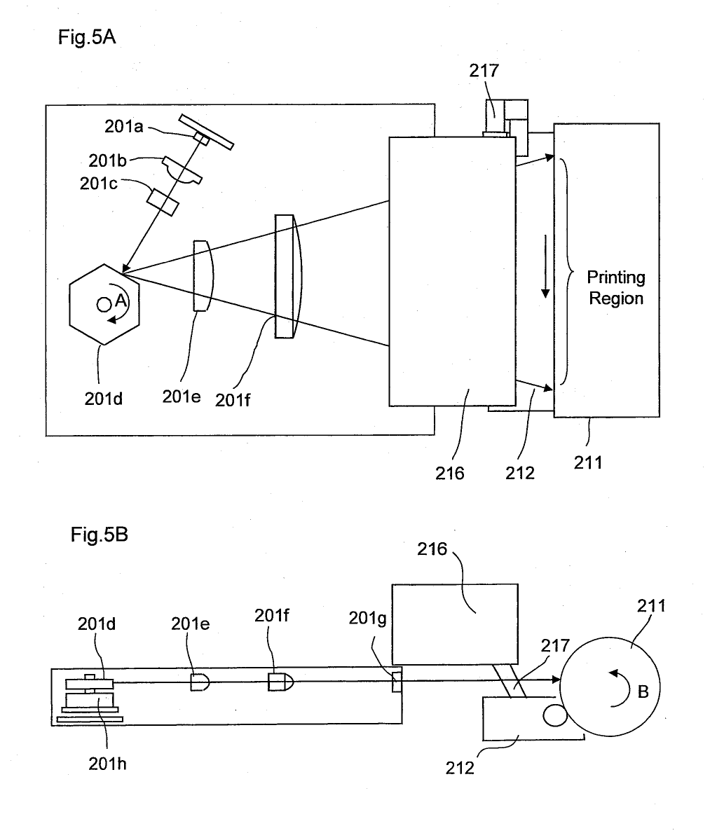

FIGS. 5A and 5B show diagrams schematically illustrating an internal configuration of the LSU 201, and an arrangement of the LSU 201, the developing device 212, the toner cartridge 216, and the photoconductor drum 211 according to the present embodiment. FIG. 5A is a top view, and FIG. 5B is a side view.

As shown in FIG. 5, a laser beam is emitted from a laser diode 201a, which is a laser source. The emitted laser beam is converged by the collimator lens 201b in a first scanning direction (substantially horizontal direction), and is then converged by a cylindrical lens 201c in a second scanning direction (substantially vertical direction). Thereafter, the laser beam is incident on side mirror surfaces of a rotating polygonal mirror 201d, and reflected therefrom. The polygonal mirror 201d rotates at a predetermined speed in a direction as indicated by an arrow A. Due to the rotation of the polygonal mirror 201d, a reflection angle of the laser beam changes, and the laser beam reflected from the polygonal mirror 201d will be a scanning beam which is deflected in the first scanning direction. The scanning beam passes through fθ lenses 201e and 201f, which have fθ characteristics, and also passes through a dust-proof glass 201g, and is outputted outside the LSU 201.

The emitted scanning beam travels through the space between the developing device 212 and toner cartridge 216 located thereabove, reaches the photoconductor drum 211, and scans the peripheral surface of the photoconductor drum 211 in the first scanning direction, that is, in a direction in parallel to the rotation axis of the photoconductor drum 211. The photoconductor drum 211 is rotary driven in a direction indicated by an arrow B. Upon exposure to the scanning beam, the photoconductor drum 211 has an electrostatic latent image formed on the peripheral surface thereof.

Variation in the exposure point and fitting of the LSU In FIG. 3, a distance between a laser beam emitting part in the LSU 201 and the center of the photoconductor drum 211 is 50 mm. The exposure point is arranged at a position which is on the peripheral surface and 2 mm higher than the horizontal plane that includes the rotation axis of the photoconductor. Since positional errors may occur when the image forming apparatus is assembled and the photoconductor drum 211 and the LSU 201 are fitted, an allowable range of variation in the position of the exposure point L in the vertical direction is set to 3 mm in width.

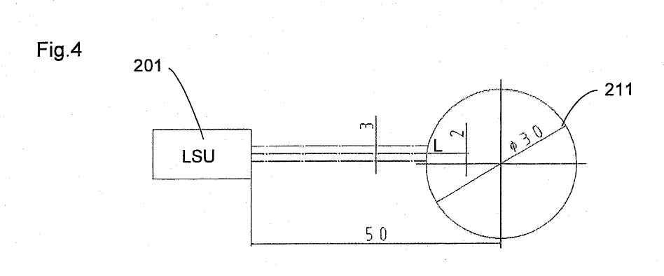

FIG. 4 is a diagram schematically showing that the exposure point is arranged so that a position higher than the central axis of the photoconductor is exposed in an embodiment of the present invention. In FIG. 4, a standard position of the exposure point is situated at a position 2 mm higher than the horizontal plane that includes the rotation axis of the photoconductor drum 211, and the allowable range of variation in the exposure point L on the peripheral surface of the photoconductor drum 211 is 3 mm in width having the exposure point L as its center. In other words, a lowest exposure point is 0.5 mm higher than the central axis of the photoconductor, and a highest exposure point is 3 mm higher than the central axis of the photoconductor. The space between the developing device 211 and the toner cartridge 216 is determined in view of such variation in the exposure point so as not to interrupt the scanning beam.

In addition to the above-described embodiment, it is possible to provide variously modified embodiments of the present invention. Those modified embodiments should be construed as being within the scope of the present invention. Further, the present invention should be construed to include anything within the scope of the appended claims, and any and all equivalents and variations within the same scope.

1. An image forming apparatus comprising:
a cylindrical photoconductor used for image formation in an electrophotographic process;
a laser scanning section that includes a polygonal mirror which rotates on its axis, and a laser beam source, and that allows a laser beam emitted from the laser beam source to reflect off the polygonal mirror and then allows a reflected laser beam to irradiate a peripheral surface of the photoconductor, so that an electrostatic latent image is formed on the peripheral surface;
an image development section for developing the electrostatic latent image into a toner image by using a toner; and
a toner storage section for storing the toner to be supplied to the image development section,
wherein the image development section is disposed lower than a central axis of the photoconductor and in contact with the peripheral surface thereof,
the toner storage section is disposed above the image development section so as to form a space therebetween, and
the laser scanning section is disposed so that the rotation axis of the polygonal mirror extends in a vertical direction, and the laser beam reflected from the polygonal mirror reaches to the photoconductor through the space and irradiates a portion of the peripheral surface, which is higher than the central axis of the photoconductor.

2. The image forming apparatus according to claim 1, further comprising:
a vertical transport path configured to pass a printing sheet upward while the printing sheet comes in contact with a part of the peripheral surface of the photoconductor;
a transfer section for transferring the toner image, which is developed by the image development section, from the peripheral surface of the photoconductor onto the printing sheet;
a fixing section that is disposed where the printing sheet is transported to after passing through the transfer section; and
a reverse transport path for reversing the printing paper which has passed through the fixing section, and circulating the printing paper to the transfer section,
wherein the vertical transport path guides the printing sheet to the transfer section upward, the printing sheet having been circulated through the fixing section and the reverse transport path after the toner image has been transferred thereonto once in the transfer section.

3. The image forming apparatus according to claim 1,
wherein the image development section is configured to develop the electrostatic latent image in a region that faces the peripheral surface of the photoconductor and extends along the central axis of the photoconductor,
the image forming apparatus further comprises a toner transport section that is disposed at one end of the region of the image development section and communicates the toner storage section with the image development section, and
the toner transport section transports the toner stored in the toner storage section to the image development section.

4. The image forming apparatus according to claim 1, wherein the laser scanning section further includes a bearing that supports the rotation axis of the polygonal mirror, and
the bearing is formed from a hydrodynamic bearing.

5. The image forming apparatus according to claim 1, further comprising a charging section for charging the peripheral surface of the photoconductor,
wherein the charging section is disposed between the toner storage section and the photoconductor.

6. The image forming apparatus according to claim 2,
wherein the image development section is configured to develop the electrostatic latent image in a region that faces the peripheral surface of the photoconductor and extends along the central axis of the photoconductor,
the image forming apparatus further comprises a toner transport section that is disposed at one end of the region of the image development section and communicates the toner storage section with the image development section, and
the toner transport section transports the toner stored in the toner storage section to the image development section.
